(19) United States
(12) Patent Application Publication
(10) Pub. No.: US 2016/0105474 A1
(43) Pub. Date: Apr. 14, 2016

(54) INTEGRATED SYSTEM OF COMMUNICATION BETWEEN PEOPLE AND VEHICLES FOR EVENT GENERATION AND AUTOMATIC CONTROL OF A MATERIAL PROCESS

(71) Applicant: LOCALIZA RENT A CAR S.A., Belo Horizonte (BR)

(72) Inventors: Alberto Wagner TEIXEIRA CAMPOS, Belo Horizonte (BR); Fabricio Orlando DAMASCENO, Belo Horizonte (BR); Gustavo GONTIJO LEAL, Belo Horizonte (BR)

(21) Appl. No.: 14/664,003

(22) Filed: Mar. 20, 2015

(30) Foreign Application Priority Data
Oct. 13, 2014 (BR) 10 2014 025485 4

(51) Int. Cl. H04L 29/06; H04L 29/08

(52) U.S. Cl. CPC H04L 65/403; H04L 67/12; H04L 67/22

(57) ABSTRACT

An integrated system of communication between people and vehicles involving a diagnostic device installed in the vehicle, a host platform and a personal mobile device, the system being an integrated way of conversation in real-time between individuals and vehicles for generation of automatic event and control of business processes, specifically, but not limited to fleet management and leasing of vehicles.

### CROSS-REFERENCE TO RELATED APPLICATIONS

Not applicable.

### STATEMENT REGARDING FEDERALLY SPONSORED RESEARCH OR DEVELOPMENT

Not applicable.

### NAMES OF THE PARTIES TO A JOINT RESEARCH AGREEMENT

Not applicable.

### INCORPORATION-BY-REFERENCE OF MATERIALS SUBMITTED ON A COMPACT DISC

Not applicable.

### BACKGROUND OF THE INVENTION

1. Field of the Invention

The present invention refers to a system of multipoint communication between people and automotive vehicles simulating a real time conversation between them, notably applied to fleet management and the provision of service for the leasing of vehicles, but not limited to them.

2. Description of Related Art Including Information Disclosed Under 37 CFR 1.97 and 37 CFR 1.98

The available techniques involve the monitoring of vehicles from the data collection from the car and its driveability through the employment of various on-board diagnostic devices that work associated with wireless networks. In some achievements are described procedures to control remotely the performance of the vehicle and the driver.

It happens that the current techniques provide the means to transfer data between vehicles and host technological platforms with ow interactivity of communication with the people, which implies the need for complementary manual interventions for viewing, obtainment of collected data and transmissions of answers.

The problem that remains is that the implementation of these isolated operations generate several disadvantages, including, but not limited to these, the long time for access and recovery of data, loss of dynamics of transference of data from the platform to the people, difficulties and limitations for the construction of historical bases and statistics with the vehicle data and the drivers.

### BRIEF SUMMARY OF THE INVENTION

The integrated communication system here disclosed aims to solve the inconveniences pertaining to current transmissions of data collected from vehicles and people establishing a multipoint conversation between cars, people and host platforms in real time.

In this way, the present invention aims to make immediate and comprehensive the response to consultation by systemic information allocated in platform and information collected from vehicles.

Another objective is to generate automatic events for the members of the communication system in accordance with the interpretations rendered by the platform and the user experience.

It is another objective of the invention allow the structuring in platform of historical bases and statistics of vehicles and users of the system.

These objectives are achieved by incorporation of a communication system that integrates and coordinates the transmission of information between people and vehicles.

Thus, the present invention has as technical effect provide an integrated system of multi-point communication between people, vehicles and host platform in real time, so as to allow greater automaticity and fluidity in the communication between them, specifically, the intercommunication between vehicles in a fleet, its managers and cars' drivers.

Thus, the main advantages of the invention are: faster response to requests of users; automatic information delivery through the generation of programmed automatic events and issued by the platform according to the data collected and stored and as the experience of the members of the communication system; use in real-time of collected data by implanted devices in cars from the fleet; operational optimization.

Another benefit of the invention lies in the fact that the present system of communication can be applied on other material processes in addition to fleet management and leasing of vehicles.

### BRIEF DESCRIPTION OF THE SEVERAL VIEWS OF THE DRAWINGS

FIG. 1 is a schematic view of the integrated system of communication between people and vehicles (transmissions).

FIG. 2 is a schematic view of the integrated system of communication between people and vehicles (conversation).

FIG. 3 is a schematic flowchart of the integrated system of communication between people and vehicles illustrated from the user request.

FIG. 4 is a schematic flowchart of the integrated system of communication between people and vehicles illustrated from the generation of automatic events.

FIG. 5 is a schematic flowchart of the integrated system of communication between people and vehicles illustrating the structuring of historical bases and statistics with data generated by the system.

FIG. 6 is a schematic flowchart of the integrated system of communication between people and vehicles illustrating the insertion of the vehicle.

FIG. 7 is a schematic flowchart of the integrated system of communication between people and vehicles illustrating the insertion of the user.

FIGS. 8 to 8.8 are illustrations of the screens of the platform of integrated system of communication between people and vehicles.

FIGS. 9 to 9.2 are illustrations of the screens of the user interface of the integrated system of communication between people and vehicles.

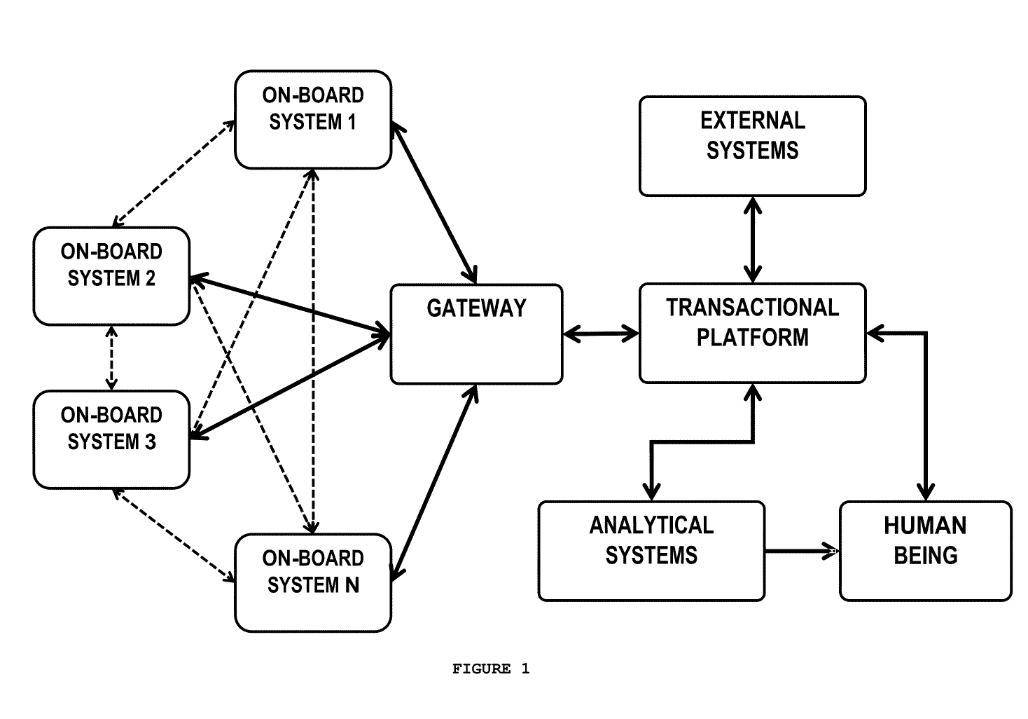

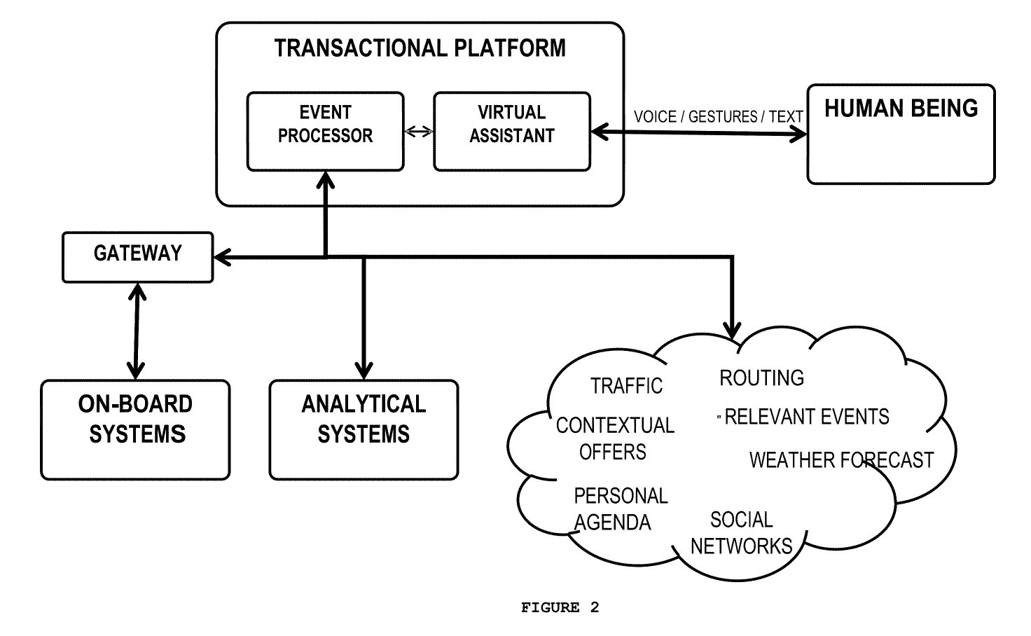

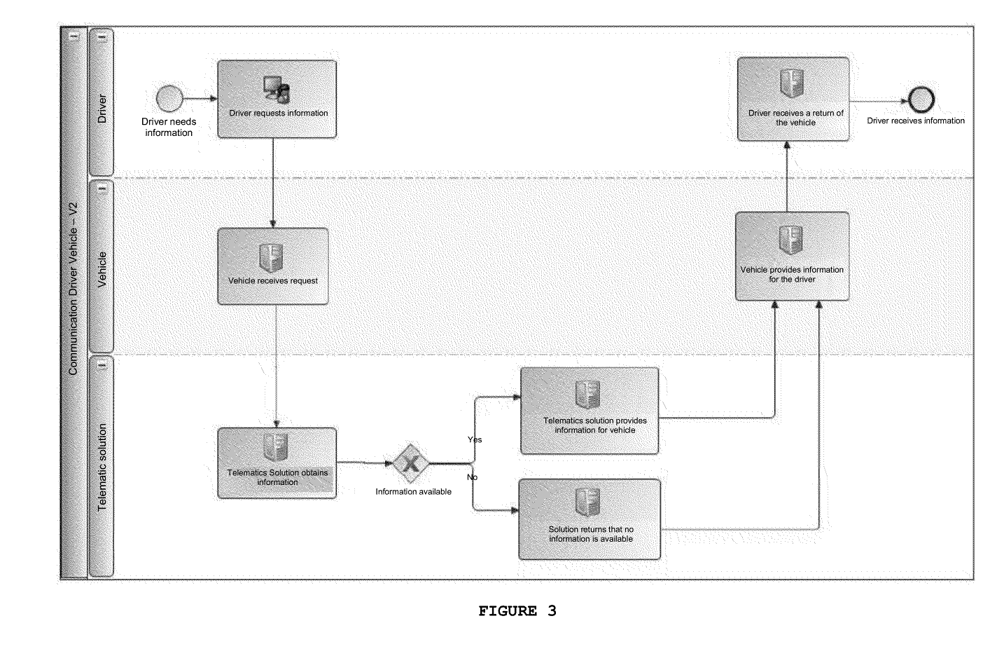

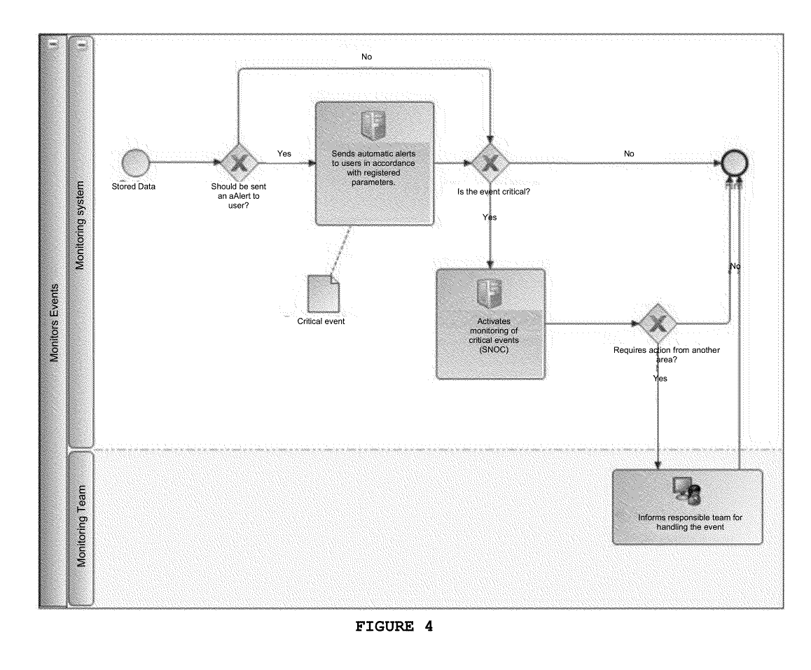

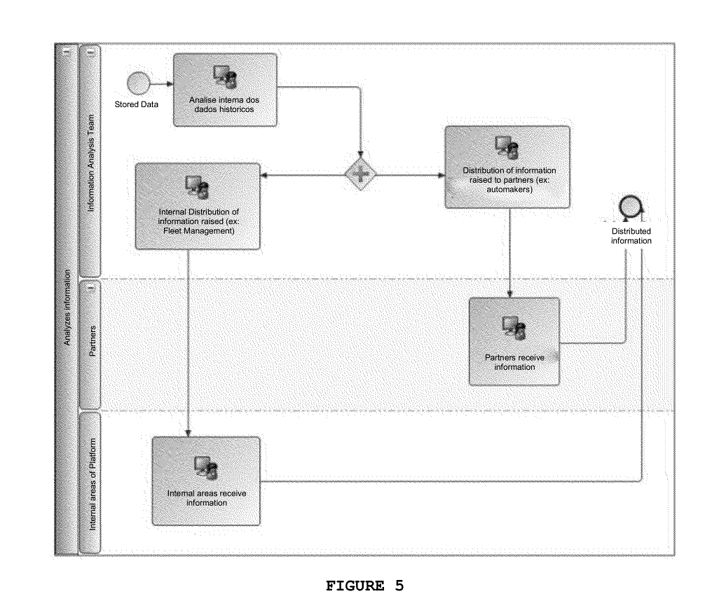

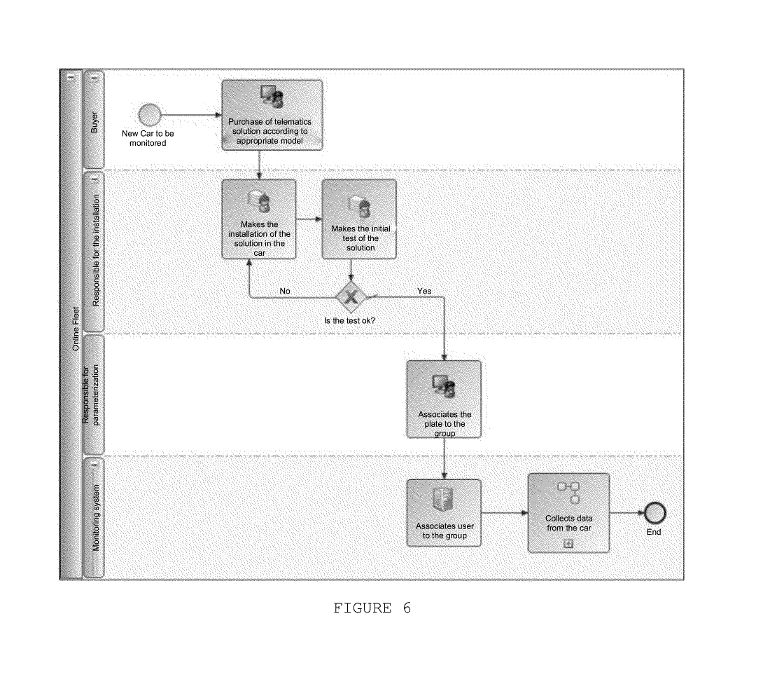

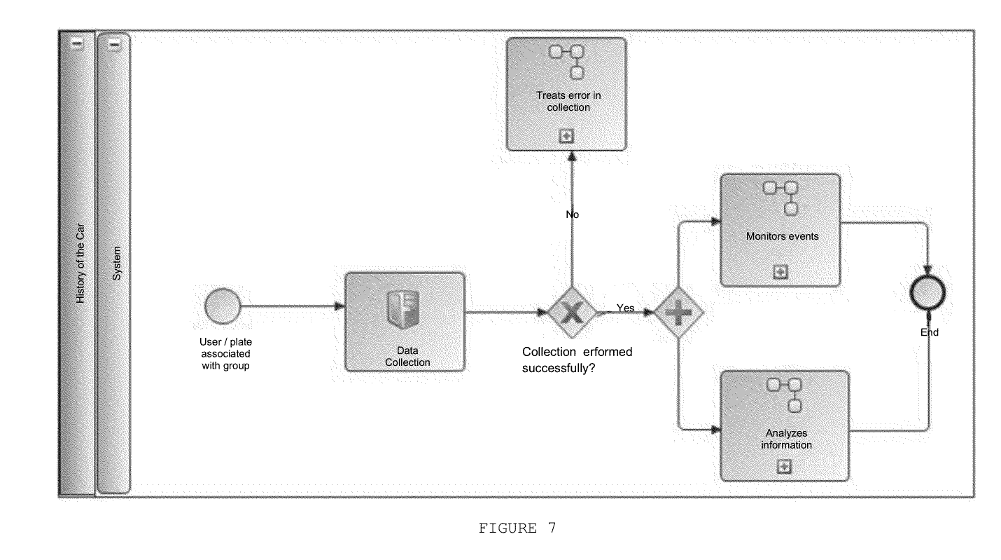

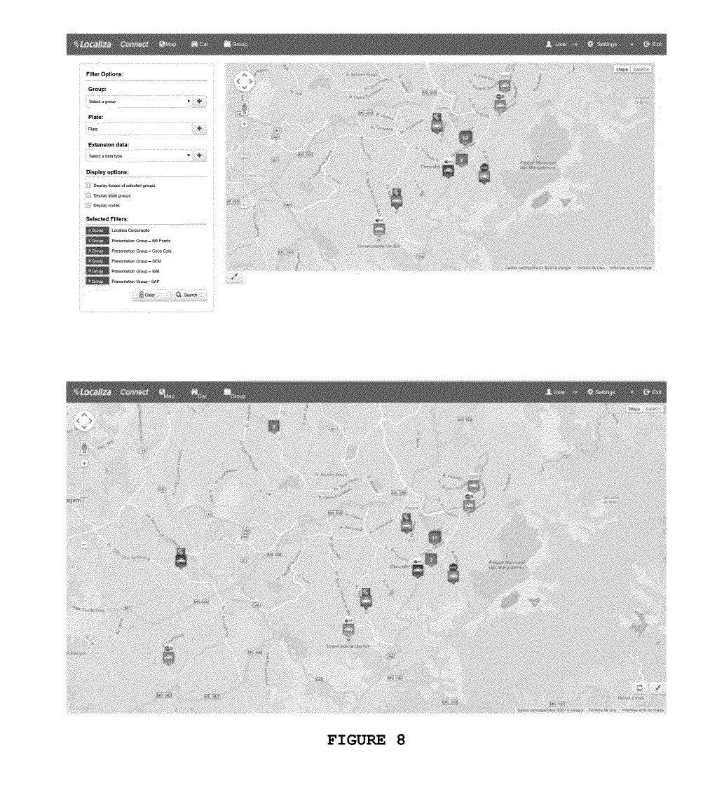

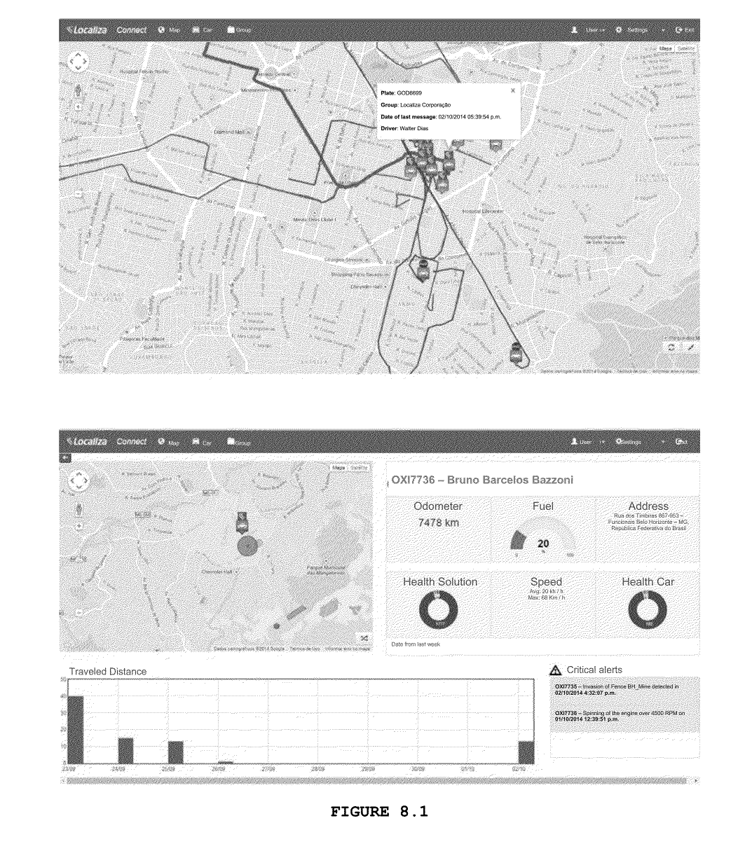

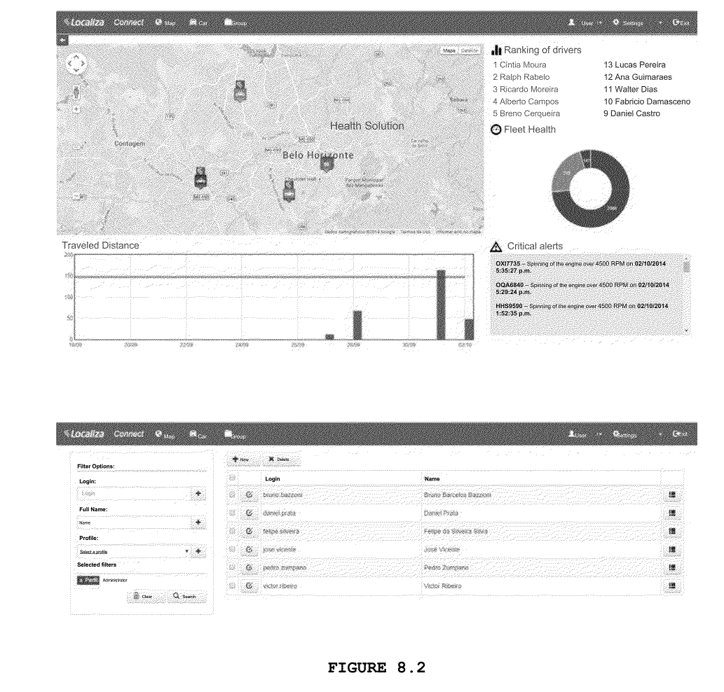

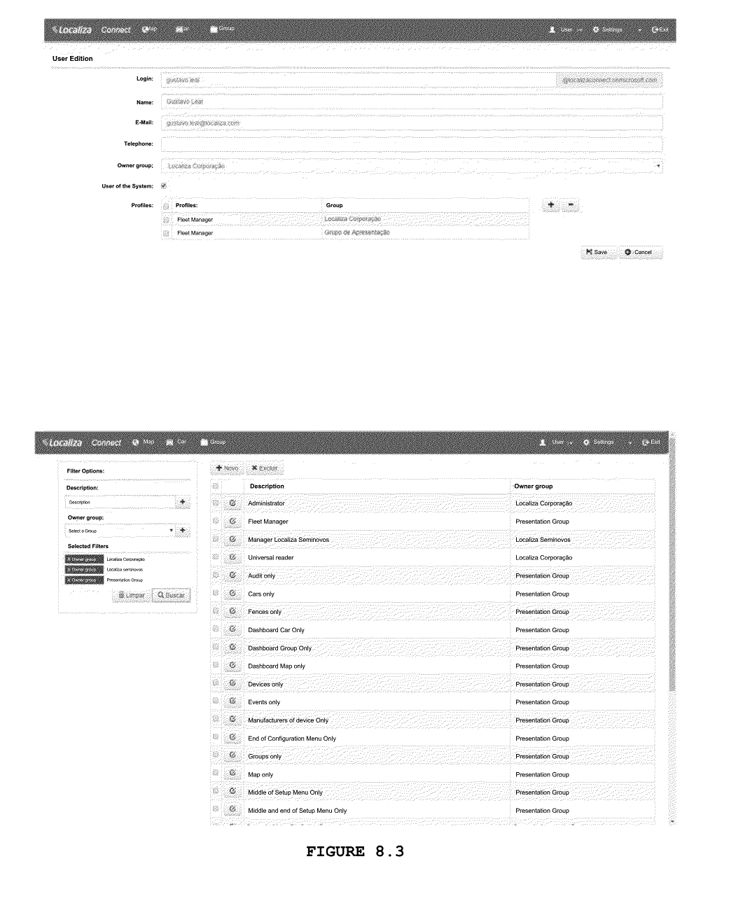

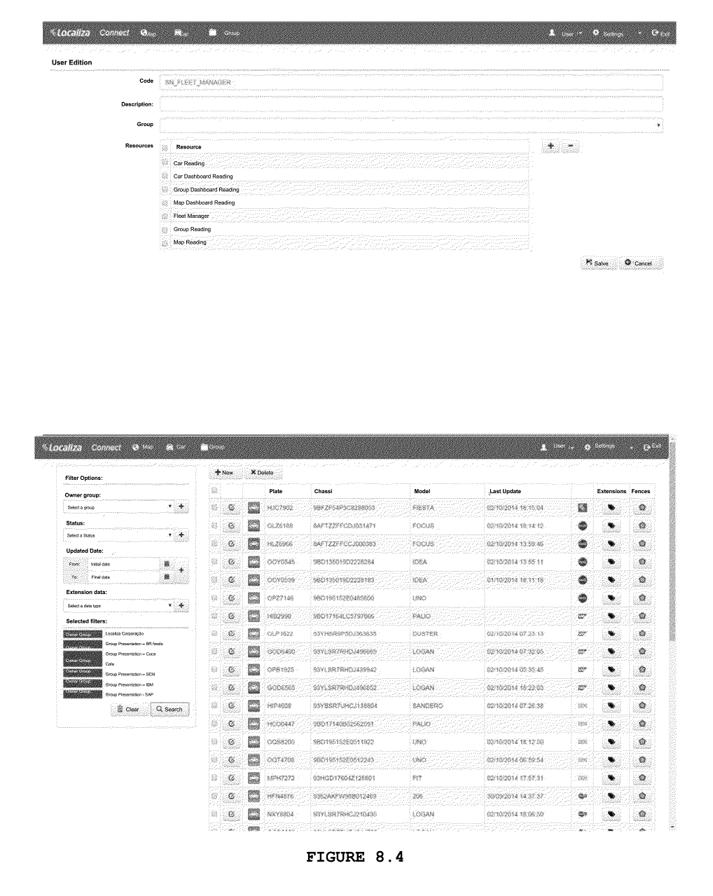

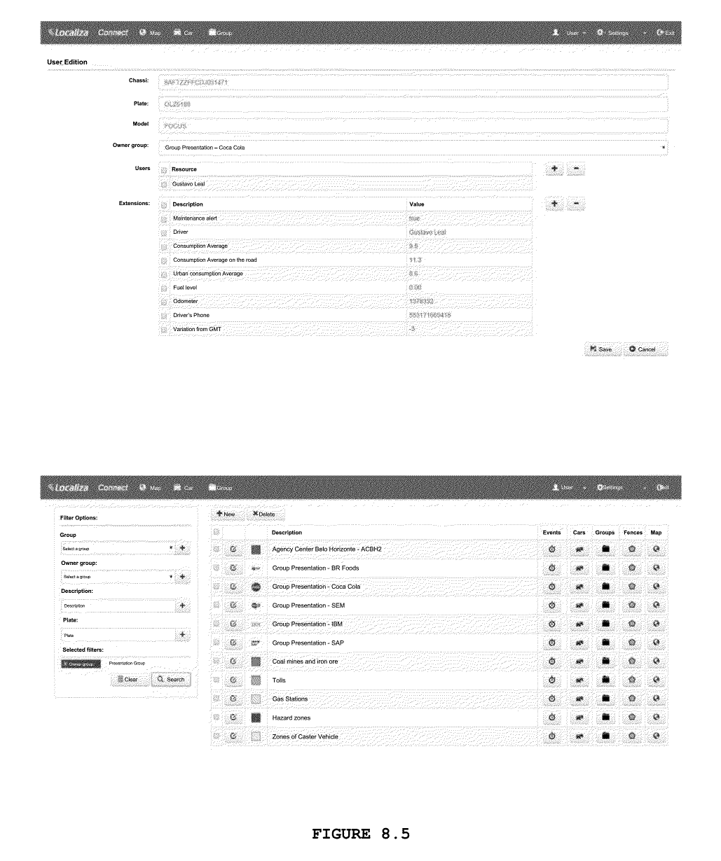

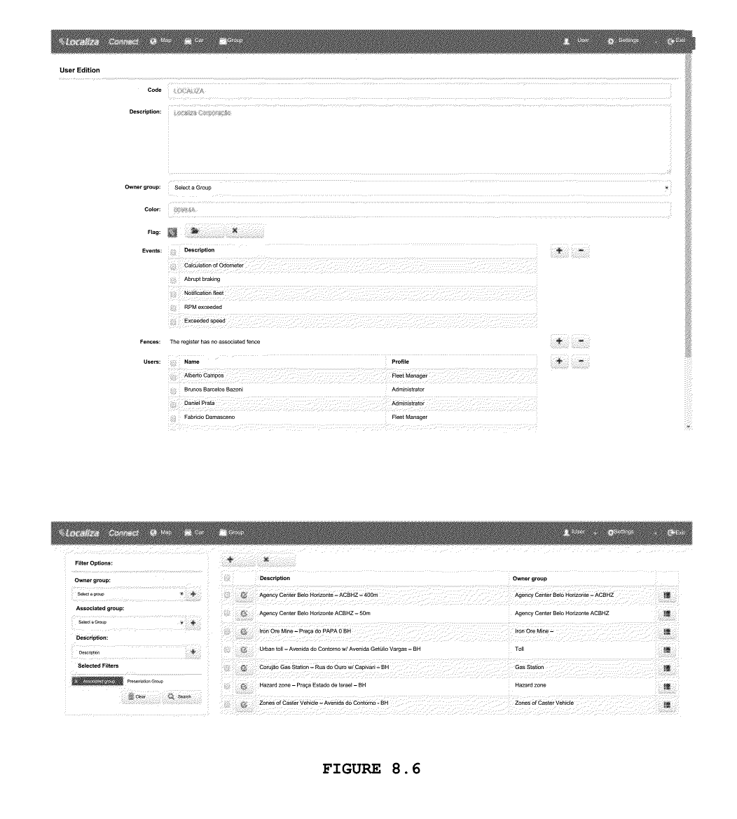

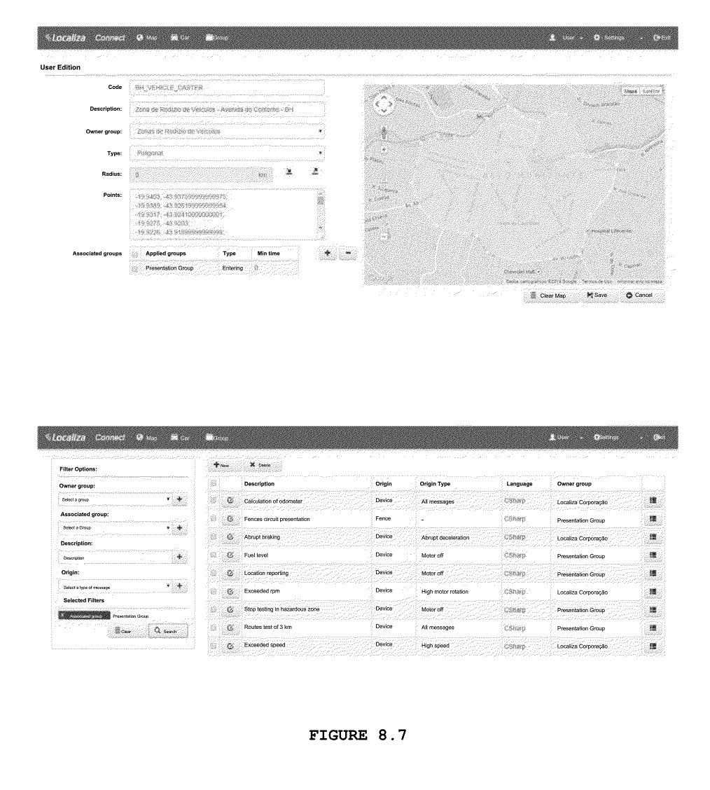

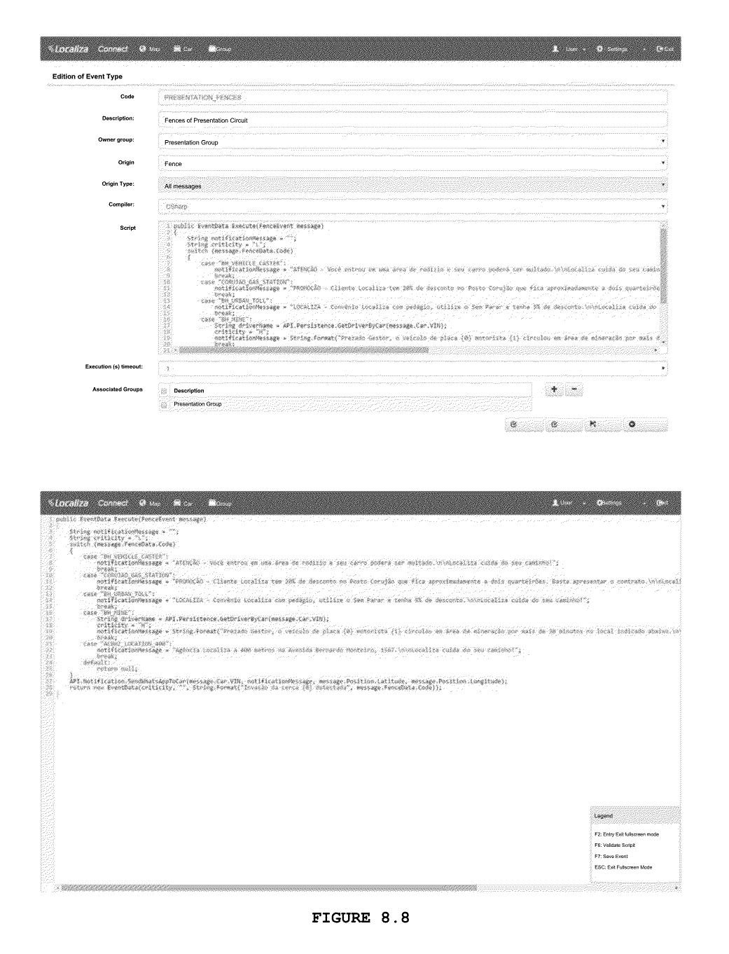

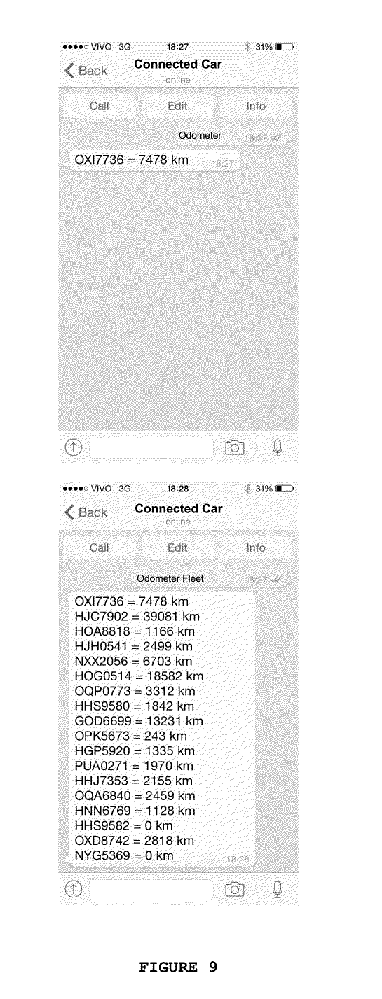

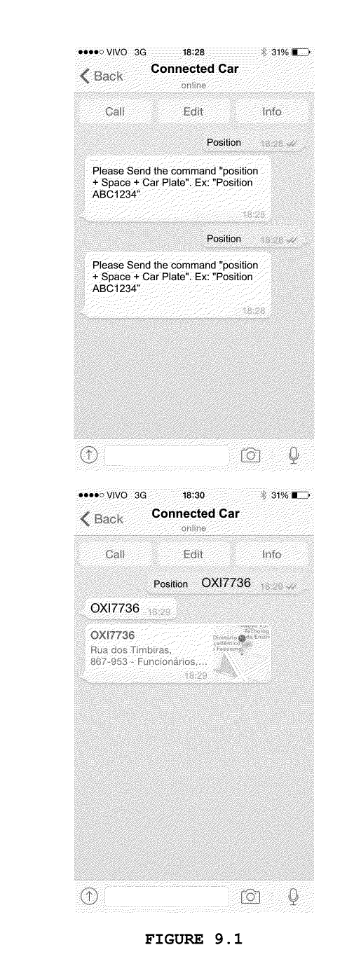

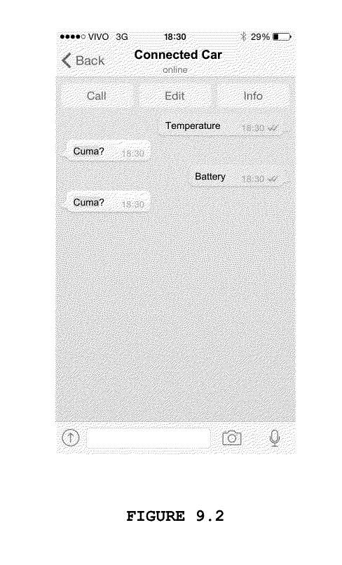

### DETAILED DESCRIPTION OF THE INVENTION

In accordance with one implementation of the invention, the system disclosed here involves a device M2M (machine-to-machine) installed in vehicles for automatic data collection (hardware with software on-board/GATEWAY) that communicates with other devices M2M or with a host central system where the collected data are interpreted and stored.

The storage of collected data follows its treatment and integration (both between the respective collected data as with other data externally obtained).

From then are available data that enables multipoint conversation between people and vehicles in two main lines described below.

(1) Data requisition: In accordance with an implementation of the invention, a conversation is initiated by a person with one or more vehicles occurs from mobile devices, on-board devices in the vehicle or personal computers by which can be send requests for information through multiple channels of communication such as: text messages (ex.: SMS), social media (ex.: WhatsApp), e-mail, besides various applications that are capable of integration with the developed platform.

To start a conversation, the person who has permission to interact with one or more vehicles sends a request for information through the channel chosen using textual language, through voice or gestures. For example: a person asking the question to his/her vehicle: “what do you think of traveling to Rio de Janeiro this weekend?” the platform processes the data relating to this context as schedule of commitments of the requester, vehicle mechanics situation and climate forecasts at the target site to prepare a response to the requester. The platform processes and confirms the validity of the request and responds to the human being in the shortest possible time.

(2) Generation of automatic events: In accordance with another implementation of the invention, it is initiated by the developed technology platform, the generation of automatic events according to rules previously defined and configured on the platform. For this, it is used a systemic module through which it is possible to set up rules for the generation of events. The rules implemented interpret the available data through the developed platform to then generate events pertinent to the context for which they were configured.

Given the occurrence of an event, the same is recorded on the platform as available data for consultation or integration with other data. In addition to its registration, the event may result in the generation of notifications to be sent to relevant people in a context defined by one of the means of communication integrated to the platform. For example: a vehicle is parked and turned off in an area of high incidence of theft and burglaries. After that, the platform notifies the responsible for it suggesting the use of the nearest parking from that place.

Described the scenarios of possibilities for interaction between human beings and the vehicles data, it should be noted that the information generated, handled and stored open possibilities for implementation of monitoring data generated with its action on the same. Such monitoring is bolstered by defined processes, people who perform the same and technologies for viewing of existing data.

1. An integrated system of communication between people and vehicles, comprising a diagnostic device installed in the vehicle, a host platform and a personal mobile device, characterized by being an integrated way of real time conversation between individuals and vehicles for automatic event generation and control of business processes.

2. The system, according to claim 1, characterized by being accessed from requesting information from the user.

3. The system, according to claim 1, characterized by allowing the generation and sending of automatic events from the platform for people and vehicles.

4. The system, according to claim 1, characterized by providing the structuring of statistical and historic bases of vehicles and users.

5. The system, according to claim 1, characterized by being applied to fleets management, leasing of vehicles, and still, adaptable to the management of other business processes.

6. Communication process of the integrated system as defined in claim 1, characterized by a set of instructions that includes the following steps:
Driver requests information,
Vehicle receives request,
Telematics solution obtains information.
Is the information available?
If yes, solution provides information to the vehicle,
Vehicle provides information to the driver.
Driver receives vehicle return,
Driver receives information.
If not, solution returns as not available information.
Vehicle provides information to the driver.
Driver receives vehicle return,
Driver receives information.

7. Communication process of the integrated system, as defined in claim 1, characterized by a set of instructions that comprises of the following steps:
Data collected and stored.
Processing of data by the solution of the Platform.
Should the information be sent to the user?
If yes, sends automatic alerts to the user in accordance with parameters registered.
If not, is the event critical?
If not, finish.
If critical, triggers monitoring of critical events.
Does it require action from another area?
If not, finish.
If yes, informs responsible team for dealing with the event.

8. Communication process of the integrated system, as defined in claim 1, characterized by a set of instructions that comprises the following steps:
Stored Data.
Analysis by the platform.
Internal distribution of raised information (Ex.: fleet management).
Internal areas receive the information.
Distribution of raised 5 information to third parties (Ex.: automakers),
Partners receive the information,
Distributed Information.

9. Communication process of the integrated system, as defined in claim 1, characterized by a set of instructions that consists of the following steps:
Vehicle to be inserted,
Selection of telematics solution according to the model,
Installation on the vehicle.
Solution test.
Is the test ok?
If not, repeats/verifies installation,
If yes, associates plate to the group,
Associates a user to the group.
Collects data from the vehicle.

10. Communication process of the integrated system, as defined in claim 1, characterized by a set of instructions that comprises the following steps:
User/plate associated to the group,
Data collection,
Did collection perform successfully?
If not, treats error in the collection.
If yes, analyzes information and monitors events.
